(19) United States
(12) Patent Application Publication
(10) Pub. No.: US 2021/0129272 A1
(43) Pub. Date: May 6, 2021

(54) Solder for Soldering Nickel Based Superalloys

(71) Applicant: National Chung-Shan Institute of Science and Technology, Taoyuan City (TW)

(72) Inventors: Chao-Yu Lin, Taoyuan City (TW); Chao-Nan Wei, New Taipei City (TW); Chien-Hung Liao, Taoyuan City (TW); Hui-Yun Po, Taoyuan City (TW); Sheng-Long Lee, Taoyuan City (TW); Yu-Chih Tseng, Taoyuan City (TW); Vun-Shing Chengn, Taichung City (TW)

(21) Appl. No.: 16/667,920

(22) Filed: Oct. 30, 2019

(51) Int. Cl. B23K 35/30; B23K 35/02; C22C 19/05

(52) U.S. Cl. CPC B23K 35/304; B23K 2103/26; C22C 19/056; B23K 35/0227

(57) ABSTRACT

The present invention provides a solder for nickel based superalloy soldering. The solder includes 11 wt % to 13 wt % chromium, 5.0 wt % to 7.0 wt % aluminum, 3.5 wt % to 5.0 wt % molybdenum, 1.5 wt % to 2.5 wt % niobium, 0.4 wt % to 1.0 wt % titanium, 0.03 wt % to 0.07 wt % carbon, 0.05 wt %-0.15 wt % zirconium, 0.001 wt % to 0.1 wt % boron and remainder nickel or other inevitable impurities, thereby reducing occurrence of soldering hot cracking and insufficient weld bead strength in nickel based superalloy raw materials during soldering.

### BACKGROUND OF THE INVENTION

### 1. Field of the Invention

The present invention relates to a solder for soldering nickel based superalloys, and more particularly, to a solder for TIG welding of nickel based superalloys.

### 2. Description of the Prior Art

Conventional solders are usually made of tin alloy and thus called tin solders, which are low-melting alloys. Solders are used to adhere to and join metal workpiece(s) together during soldering, and have a lower melting point than the metal workpiece(s) to be joined. Solders are typically known as soft-solders with a melting point in a range of 90 degrees Celsius to 450 degrees Celsius. Soft soldering is widely adopted to connect electronic components and circuit boards, plumbing, sheet metal work, and so on. Hand soldering often uses a soldering iron. Soldering performed using a solder with a melting point higher than 450 degrees Celsius is called hard soldering, silver soldering, or copper brazing.

Tin-lead solders, also referred to as soft solders, are commercially available with lead concentrations between 5% and 70% by weight. The greater the tin concentration, the stronger the tensile strength and shear strength. Composition of lead-free solders may include tin, copper, silver, bismuth, indium, zinc, antimony, and so on. Lead-free solders may have melting points from 5 to 20 degrees Celsius higher than lead solders; however, lead-free solders with much lower melting points exist.

Hard solders have melting points higher than 450 degrees Celsius. Alloys of silver and copper and alloys of silver and copper are the most common hard solders. To fabricate silverware and jewelry, special hard solders after tested are required. Metal composition ratio in these special hard solders is generally similar to that in the metal workpiece(s) to be joined. Generally, lead is not used in the special hard solders, which vary in hardness and type. The special hard solders (listed in descending order of hardness and melting points) are typically divided into “enameling”, “hard”, “medium” and “easy” solders according to melting points. The melting point of the enameling solders is the highest, and even close to the melting point of the metal workpiece(s) to be joined in order to prevent the joint desoldering during other heating processes. To avoid other previously soldered joints from melting during soldering, solders of different melting points should be used in batches in a manufacture process.

Conventional gas tungsten arc welding (GTAW), also referred to as tungsten inert gas (TIG) welding, is an arc welding process that uses a non-consumable tungsten electrode to produce weld. During TIG welding, weld areas are protected from atmospheric contamination by means of a shielding gas (normally noble gases such as argon); a solder (a filler metal) is regularly used in combination, though certain autogenous welds do not require it. A constant-current welding power supply, which is provided by conduction across the arc through highly ionized gas (known as plasma) and metal vapors, produces electrical energy when welding.

TIG welding is commonly utilized to weld thin sheets of stainless steel and non-ferrous metals such as aluminum, magnesium, and copper alloys. Compared with a manual hand-held arc welding and gas metal arc welding, TIG welding grants greater control and allows for stronger, higher quality welds. However, TIG welding is comparatively more complex and difficult to master, and furthermore, its welding speed is slower than other welding techniques.

Conventional Inconel-713-LC (IN-713LC) nickel based superalloys are cast nickel based high-temperature superalloys, which belong to aging-harden type nickel based superalloys. IN-713LC nickel based superalloys offer reliable high temperature strength and corrosion resistance. Therefore, IN-713LC nickel based superalloys are currently crucial material to fabricate key high temperature resistant components of military missile propellers, turbochargers and turbine blades for aerospace and automotive industries. Nevertheless, casting shape of IN-713LC nickel based superalloys is complex, and blade thicknesses of IN-713LC nickel based superalloys vary dramatically. All these make casting and feeding difficult; moreover, defects such as holes, misrun or cold shuts, shrinkage cavities, and hot cracking often form on casting workpiece(s) during casting, resulting in low qualified product yield and high manufacture costs. Therefore, welding technology is widely adopted to restore defective turbine blade casting workpiece(s) in the current industry to improve product economics and product qualified rate effectively.

In order to improve the quality of nickel based superalloy soldering, there are a great deal of related research. For example, in U.S. Patent No. US20090285715A1, a welding additive material to improve weldability of nickel based superalloys includes 18.0%-20.0% of chromium (18.0%≤Cr≤20.0%), 9.0%-11.0% of cobalt (9.0%≤Co≤11.0%), 7.0%-10.0% of molybdenum (7.0%≤Mo≤10.0%), 2.0%-2.5% of titanium (2.0%≤Ti≤2.5%), 1.0%-1.7% of aluminum (1.0%≤Al≤1.7%) and 0.04%-0.08% of carbon (0.04%≤C≤0.08%). In U.S. Patent No. US20110274579A1, a welding additive material to improve weldability of nickel based superalloys includes 10.0%-20.0% chromium (10.0%≤Cr≤20.0%), 5.0%-15.0% cobalt (5.0%≤Co≤15.0%), 0.0%-10.0% molybdenum (0.0%≤Mo≤10.0%), 0.5-3.5% tantalum (0.5%≤Ta≤3.5%), 0.0%-5.0% titanium (0.0%≤Ti≤5.0%), 1.5%-5.0% aluminum (1.5%≤Al≤5.0%) and 0.3%-0.6% boron (0.3%≤B≤0.6%), In U.S. Patent No. US20070090167A1, a welding additive material to improve weldability of nickel based superalloys includes 17.5%-20.0% chromium (17.5%≤Cr≤20.0%), 10.0%-12.0% cobalt (10.0%≤Co≤12.0%), 9.0%-10.5% molybdenum (9.0%≤Mo≤10.5%), 0.1%-3.3% titanium (0.1%≤Ti≤3.3%), 1.4%-1.8% aluminum (1.4%≤Al≤1.8%), 0.04%-0.12% carbon (0.04% C 0.12%) and 0.003%-0.01% boron (0.003%≤B≤0.01%). In Taiwan Patent No. TWI562848B, nickel solder materials of high corrosion resistance able to bond various stainless steel components at relatively low temperature includes 15.0 wt %-30.0 wt % chromium (15.0%≤Cr≤30.0%), 6.0 wt %-18.0 wt % copper (6.0% Cu 18.0%) and 1.0 wt %-5.0 wt % molybdenum (1.0%≤Mo≤5.0%).

However, from a soldering restoration process of IN-713LC nickel based superalloys, soldering hot cracks probably occurs in casting weld bead and heat-affected region, which makes soldering restoration quality too poor to use. Even if the soldering restoration for casting shrinkage cavities is completed, soldering restoration marks on the casting workpiece(s) are noticeable under subsequent X-ray inspection, and the casting workpiece(s) may hence be judged as unqualified.

Therefore, there is a great need in the industry to develop a solder for nickel based superalloy soldering, which increases yield of nickel based superalloy soldering products by solving problems such as soldering hot cracking and insufficient weld bead strength.

### SUMMARY OF THE INVENTION

To obviate or at least alleviate the problems encountered in prior art, it is an objective of the present invention to provide a solder for nickel based superalloy soldering including chromium, aluminum, molybdenum, columbium, titanium, carbon, zirconium, boron and remainder nickel or other inevitable impurities, thereby reducing occurrence of soldering hot cracking and insufficient weld bead strength in the nickel based superalloy raw materials during soldering.

To achieve the foregoing objective, the present invention provides a solder for nickel based superalloy soldering including a nickel based superalloy raw material and a solder. The solder includes 11 wt % to 13 wt % chromium, 5.0 wt % to 7.0 wt % aluminum, 3.5 wt % to 5.0 wt % molybdenum, 1.5 wt % to 2.5 wt % niobium, 0.4 wt % to 1.0 wt % titanium, 0.03 wt % to 0.07 wt % carbon, 0.05 wt %-0.15 wt % zirconium, 0.001 wt % to 0.1 wt % boron and remainder nickel or other inevitable impurities, thereby reducing occurrence of soldering hot cracking and insufficient weld bead strength in the nickel based superalloy raw material during soldering.

In a solder for nickel based superalloy soldering of the present invention, a proportion of boron in the solder is 0.015 wt % to 0.1 wt %.

In a solder for nickel based superalloy soldering of the present invention, a proportion of boron in the solder is 0.05 wt %.

In a solder for nickel based superalloy soldering of the present invention, the soldering is tungsten inert gas (TIG) welding.

In a solder for nickel based superalloy soldering of the present invention, the solder is formed into a soldering rod by vacuum arc melting or vacuum induction melting.

In a solder for nickel based superalloy soldering of the present invention, the nickel based superalloy raw material is a nickel based superalloy casting or a nickel based superalloy.

Other objectives, advantages and features of the present invention will be apparent from the following description referring to the attached drawings.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a slotted nickel based superalloy raw material test sample according to an example of the present invention.

FIG. 2 is a schematic diagram of a soldering experimental result with a current commercial nickel based superalloy solder.

FIG. 3 is a schematic diagram of a soldering experimental result with a solder for nickel based superalloy soldering according to an example of the present invention.

FIG. 4 is a schematic diagram of an X-ray examination result with a current commercial nickel based superalloy solder.

FIG. 5 is a schematic diagram of an X-ray examination result with a solder for nickel based superalloy soldering according to an example of the present invention.

### DETAILED DESCRIPTION

In the following description, for purposes of explanation, numerous specific details are set forth in order to provide a thorough understanding of one or more aspects of the present invention. It may be evident, however, to one skilled in the art that one or more aspects of the present invention may be practiced with a lesser degree of these specific details.

When soldering nickel based superalloys, the most common soldering defects may be solidification cracking and liquefaction cracking. Both the solidification cracking and the liquefaction cracking belong to soldering hot cracking and have the following characteristics: (1) the solidification cracking and the liquefaction cracking occur in soldering solidification processes. (2) The solidification cracking and the liquefaction cracking occur along crystal grain boundary. (3) Liquid film exists at solid crystal grain boundary when the solidification cracking and the liquefaction cracking occurs.

The present invention provides a solder composition for nickel based superalloy soldering. The solder composition includes specific elements such as chromium, aluminum, molybdenum, columbium, titanium, carbon, zirconium, boron, nickel and the like. By combining aluminum and titanium with nickel, aging-enhanced γ′ phase is formed to increase weld bead strength. A trace amount of Boron of 0.1 wt % at the most is added, thereby avoiding formation of boron-rich intermetallic compound (harmful phase). The trace amount of Boron may reduce alloy melting points, improve alloy wettability, enhance microstructure and mechanical properties of weld bead and heat-affected region of nickel based superalloy, and solve problems of hot cracking of the nickel based superalloy.

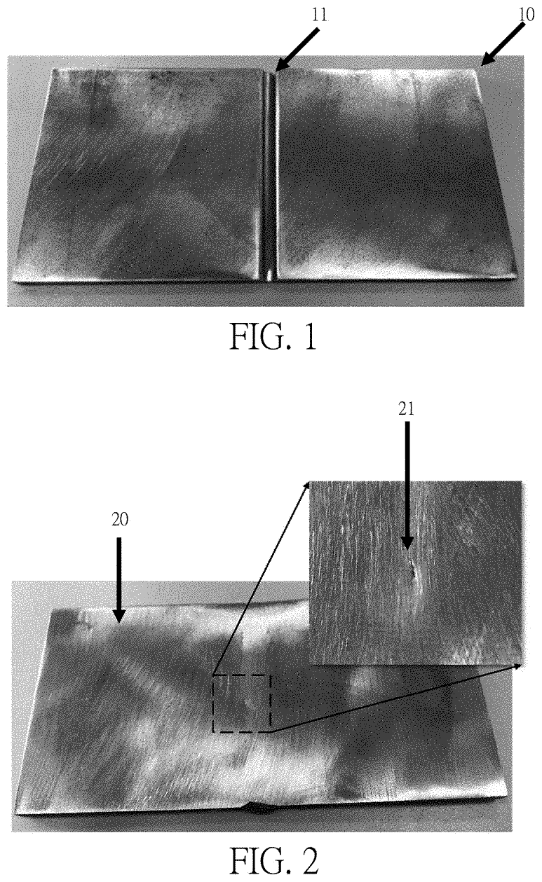

Please refer to FIG. 1 to FIG. 5, which are experimental results of the solder for the nickel based superalloy soldering of the present invention. A solder for nickel based superalloy soldering in the present invention includes 11 wt % (namely, 11% weight percentage) to 13 wt % chromium, 5.0 wt % to 7.0 wt % aluminum, 3.5 wt % to 5.0 wt % molybdenum, 1.5 wt % to 2.5 wt % niobium, 0.4 wt % to 1.0 wt % titanium, 0.03 wt % to 0.07 wt % carbon, 0.05 wt %-0.15 wt % zirconium and 0.001 wt % to 0.1 wt % boron, and the remainder is nickel. In an embodiment of the present invention, an ingot is produced in by vacuum arc melting, and then the material is cut and processed into a soldering rod of substantially 2 millimeters (mm) in diameter by a CNC cutter. The actual composition of the soldering rod may be 11.8 wt % Cr, 6.1 wt % Al, 3.8 wt % Mo, 1.95 wt % Nb, 0.77 wt % Ti, 0.04 wt % C, 0.11 wt % Zr, 0.05 wt % B and 75.38 wt % Ni.

As shown in FIG. 1, a nickel based superalloy raw material IN-713LC test sample is slotted. The nickel based superalloy raw material (10) is processed into a sheet test sample of 100 mm in length, 50 mm in wide and 3 mm in thickness. Subsequently, the sheet test sample is notched by wire electrical discharge machining to form a V-shaped groove (11) having a width of 3 mm, a depth of 1.5 mm and an angle of 60 degrees. The nickel based superalloy raw material IN-713LC test sample and the soldering rod are then cleaned and decontaminated with 95% alcohol, and dried in a baking oven at 110 degrees Celsius. An argon welding (namely, a TIG welding) experiment was carried out by means of an arc welder (namely, a thermal dynamics, thermal Arc, AC/DC inverter arc welder).

To eliminate welding stress of the soldered piece formed from the soldered nickel based superalloy raw material, the soldered piece is subjected to an appropriate heat treatment. According to the heat treatment which conforms to heat treatment regulations, the soldered piece was cooled to room temperature with argon gas after vacuum solution treatment at 1177 degrees Celsius for 2 hours. Then, an artificial aging is performed at 649 degrees Celsius for 16 hours. A tensile test by a universal testing machine is initiated and results are analyzed after the heat treatment on the soldered nickel based superalloy raw material.

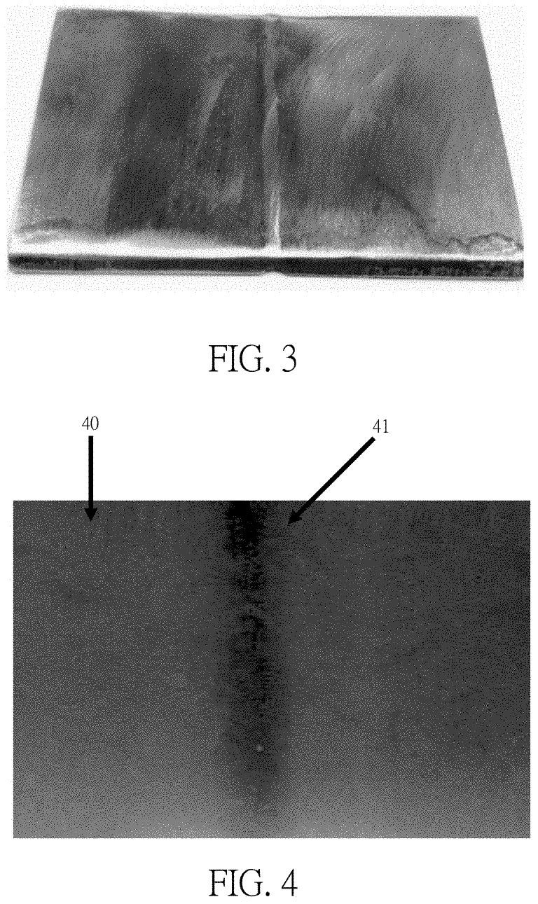

As shown in FIG. 2 and FIG. 3, test sample appearances after the TIG welding on the nickel based superalloy raw material IN-713LC test sample with a current commercial nickel based superalloy solder (shown in FIG. 2) and the solder in the embodiment of the invention (shown in FIG. 3) are presented. After the TIG welding on the nickel based superalloy raw material IN-713LC test sample, hot cracking (21) as shown in FIG. 2 is formed on the nickel based superalloy raw material (20), which is soldered with the current commercial nickel based superalloy solder. However, as shown in FIG. 3, there is no TIG welding defects on the nickel based superalloy raw material, which is soldered with the soldering rod made of the solder in the embodiment of the invention.

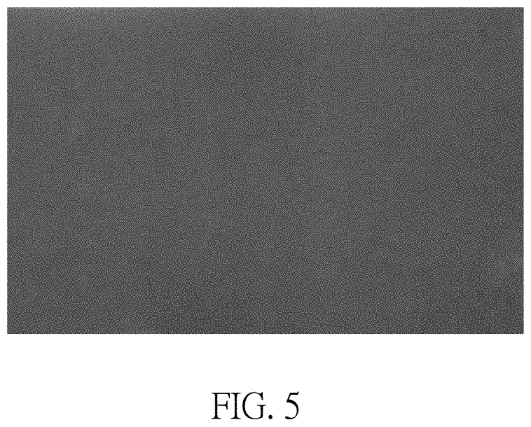

As shown in FIG. 4 and FIG. 5, the aforementioned two test samples are examined by X-ray. It is found that soldering restoration marks on the nickel based superalloy raw material (20) soldered with the current commercial nickel based superalloy solder are noticeable under X-ray inspection. For example, obvious blow holes are found in weld bead (41). On the other hand, the nickel based superalloy raw material test sample soldered with the solder in the embodiment of the invention has no obvious soldering restoration marks and defects. Accordingly, soldering quality of the solder in the embodiment of the invention is superior to that of the current commercial nickel based superalloy solder.

The following table lists tensile mechanical properties of a nickel based superalloy after heat treatment.

| | UTS | YS | El. |
|---|---|---|---|
| Type | (MPa) | (MPa) | (%) |
| IN-713LC | 950 | 810 | 10.4 |
| a current commercial solder | 612 | 477 | 4.2 |
| a solder of the invention | 860 | 714 | 7.6 |

According to the table, it is found that tensile strength (UTS), yield strength (YS) and elongation (EL) of a nickel based superalloy IN-713LC without soldering may reach 950 MPa, 810 MPa and 10.4% respectively. Tensile strength, yield strength and elongation of a soldered piece soldered with the current commercial nickel based superalloy solder are greatly reduced to 612 MPa, 477 MPa and 4.2% respectively. Tensile strength, yield strength and elongation of a (TIG welding) soldered piece soldered with the solder in the embodiment of the invention may reach 860 MPa, 714 MPa and 7.6% respectively, which are merely slightly lower than the nickel based superalloy IN-713LC without soldering. Accordingly, mechanical property of nickel based superalloy soldered with the solder in the embodiment of the invention is superior to that soldered with the current commercial nickel based superalloy solder.

One benefit of the present invention is that the solder may be used conveniently and may avoid poor solderability of the nickel based superalloy raw material (for instance, the casting of IN-713LC). Moreover, a soldering restoration process of nickel based superalloys may be carried out under standard argon welding (namely, a TIG welding) conditions without any special soldering skill. Success rate of the soldering restoration process is up to 80% or more, and weld bead strength of the nickel based superalloy soldered piece is also greatly improved (>800 MPa). Another benefit of the present invention is that the nickel based superalloy raw material (for instance, the casting of IN-713LC) may be soldering restored with the solder at a high success rate of 98% to 100% (for example, a casting of IN-713LC), and yield strength of the soldered piece after heat treatment may reach 700 MPa or more. Another benefit of the present invention is that the solder may be widely applied to other high-strength nickel based superalloy castings as well even though the solder is developed for casting defect improvement and soldering requirements of nickel based superalloys.

Although the invention has been shown and described with respect to one or more implementations, equivalent alterations and modifications will occur to others skilled in the art based upon a reading and understanding of this specification and the annexed drawings. The invention includes all such modifications and alterations and is limited only by the scope of the following claims. In addition, while a particular feature of the invention may have been disclosed with respect to only one of several implementations, such feature may be combined with one or more other features of the other implementations as may be desired and advantageous for any given or particular application.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A solder for nickel based superalloy soldering, comprising:
a nickel based superalloy raw material; and
a solder, comprising 11 wt % to 13 wt % chromium, 5.0 wt % to 7.0 wt % aluminum, 3.5 wt % to 5.0 wt % molybdenum, 1.5 wt % to 2.5 wt % niobium, 0.4 wt % to 1.0 wt % titanium, 0.03 wt % to 0.07 wt % carbon, 0.05 wt %-0.15 wt % zirconium, 0.015 wt % to 0.1 wt % boron and remainder nickel or other inevitable impurities, thereby reducing occurrence of soldering hot cracking and insufficient weld bead strength in the nickel based superalloy raw material during soldering.

2. The solder for nickel based superalloy soldering according to claim 1, wherein a proportion of boron in the solder is 0.05 wt %.

3. The solder for nickel based superalloy soldering according to claim 1, wherein the soldering is tungsten inert gas (TIG) welding.

4. The solder for nickel based superalloy soldering according to claim 1, wherein the solder is formed into a soldering rod by vacuum arc melting or vacuum induction melting.

5. The solder for nickel based superalloy soldering according to claim 1, wherein the nickel based superalloy raw material is a nickel based superalloy casting or a nickel based superalloy forging.
